(19) United States
(12) Patent Application Publication
(10) Pub. No.: US 2022/0174991 A1
(43) Pub. Date: Jun. 9, 2022

(54) METHODS OF INTERNMENT CALORIC RESTRICTION FOR IMPARTING HEALTH BENEFITS TO AN ANIMAL

(71) Applicant: Société des Produits Nestlé S.A., Vevey (CH)

(72) Inventor: Yuanlong Pan, Chesterfield, MO (US)

(21) Appl. No.: 17/528,658

(22) Filed: Nov. 17, 2021

Related U.S. Application Data
(60) Provisional application No. 63/120,777, filed on Dec. 3, 2020.

(51) Int. Cl. A23K 20/163; A23K 50/40

(52) U.S. Cl. CPC A23K 20/163; A23K 50/40

(57) ABSTRACT

The invention provides methods for treating, preventing, or delaying the onset of an organ disease in an animal and for reducing the biological age in an adult animal using an intermittent partially restricted diet. Such methods can include feeding an animal two different diets having differing caloric contents in a specific ratio to achieve such benefits.

### CROSS REFERENCE TO RELATED APPLICATION

This application claims priority to U.S. Provisional Application Ser. No. 63/120,777 filed Dec. 3, 2020, the disclosure of which is incorporated in its entirety herein by this reference.

### BACKGROUND OF THE INVENTION

### Field of the Invention

The invention relates generally to methods for providing health benefits for an animal by using specific intermittent caloric restriction diets, and particularly to methods for using feeding patterns for providing such health benefits.

### Description of Related Art

Chronic caloric restriction (CR) without malnutrition has been proven to be able to enhance both mean and maximum lifespan, promote healthy lifespan (lifespan free-from chronic diseases), and prevent, delay or reduce the incidence of many chronic diseases including cardiovascular disease, cancer, diabetes, hypertension, stroke, dementia, Alzheimer's disease, Parkinson's disease. Unfortunately, it is very difficult to practice CR for above-mentioned health benefits due to the requirement of reducing daily caloric intake for lifetime.

Several methods for mimicking CR are known in the art. For example, every other day fasting can enhance lifespan (Goodrick et al., Mech Ageing Dev 1990; 55:69-87), but fasting every other day for lifetime is also very difficult to practice. Fasting 4 consecutive days every two weeks also can increase longevity (Sogawa H, Kubo C. Mech Ageing Dev 2000; 115: 61-71.), but this approach is also very difficult for most people and animals. A fasting-mimicking diet (FMD) has been shown to reduce biomarkers and risk factors for aging, diabetes, cancer and cardiovascular disease (Wei et al., Sci Transl. Med, 2017, 9: waai8700). The FMD is low in calories, sugar, and protein, but high in unsaturated fats. Also, people have to consume the FMD five consecutive days per month for a minimum of three months in order to receive any benefit.

There is, therefore, a need for new methods for providing health benefits associated with chronic caloric restriction without the need to reduce caloric content on a daily basis.

### SUMMARY OF THE INVENTION

A method for treating, preventing, or delaying the onset of an organ disease or decline of an organ function or conditions relating thereto in an animal comprising feeding the animal a caloric maintenance diet containing calories that meet the animal's maintenance energy requirements for a caloric maintenance period and feeding the animal a caloric reduction diet containing from about 40% to about 60% of the calories contained in the caloric maintenance diet for a caloric reduction period, where the caloric maintenance period and the caloric reduction period is in a ratio of about 4:3.

A method for treating, preventing, or delaying the onset of an organ disease or decline of an organ function or conditions relating thereto in an animal comprising feeding the animal ad libitum for an ad libitum period and feeding the animal a caloric reduction diet containing from about 40% to about 60% of the animal's maintenance energy requirements for a caloric reduction period, where the ad libitum period and the caloric reduction period is in a ratio of about 4:3.

A method reducing the biological age in an adult animal or the biological age of an organ in an adult animal, the method comprising feeding the adult animal a caloric maintenance diet containing calories that meet the adult animal's maintenance energy requirements for a caloric maintenance period and feeding the adult animal a caloric reduction diet containing from about 40% to about 60% of calories that meet the adult animal's maintenance energy requirements for a caloric reduction period, where the caloric maintenance period and the caloric reduction period is in a ratio of about 4:3.

A method reducing the biological age in an adult animal or the biological age of an organ in an adult animal, the method comprising feeding the adult animal ad libitum for ad libitum period and feeding the adult animal a caloric reduction diet containing from about 40% to about 60% of calories that meet the adult animal's maintenance energy requirements for a caloric reduction period, where the ad libitum period and the caloric reduction period is in a ratio of about 4:3.

Other and further objects, features, and advantages of the present invention will be readily apparent to those skilled in the art.

### DETAILED DESCRIPTION OF THE INVENTION

### Definitions

The term “animal” means a human or other animal that can benefit from this invention for treating, preventing, or delaying the onset of an organ disease or decline of an organ function or conditions, or reducing the biological age of an animal or reducing the biological age of an organ of an animal, including avian, bovine, canine, equine, feline, hircine, murine, ovine, and porcine animals.

The term “companion animal” means domesticated animals such as cats, dogs, rabbits, guinea pigs, ferrets, hamsters, mice, gerbils, horses, cows, goats, sheep, donkeys, pigs, and the like. In one aspect, companion animal can refer to a dog and/or cat.

The term “therapeutically effective amount” means an amount of a compound disclosed herein that (i) treats or prevents the particular disease, condition, or disorder, (ii) attenuates, ameliorates, or eliminates one or more symptoms of the particular disease, condition, or disorder, or (iii) prevents or delays the onset of one or more symptoms of the particular disease, condition, or disorder described herein.

The terms “treating”, “treat”, and “treatment” embrace both preventative, i.e., prophylactic, and palliative treatment.

The term “aging” means being of advanced age such that the animal has exceeded 50% of the average lifespan for its particular species and/or breed within a species. For example, if the average lifespan for a given breed of dog is 10 years, then a dog within that breed greater than 5 years old would be considered “aging” for purposes herein. Additionally, for example, if the average lifespan for a breed of cat is 15 years, then a cat within that breed greater than 7.5 years old would be considered “aging” for the purposes herein. In an embodiment, the compositions and methods disclosed herein involve a senior animal, e.g. a senior dog or a senior cat. Animals, such as dogs and cats, are considered senior in the last 25% of their lives. As noted herein, the life span of a dog or a cat depends on its size and/or its breed, and a senior dog or senior cat can be determined based on the above calculation but using the numerical value of 75% such that the age threshold is exceeding 75% of the average lifespan.

The term “intermittent period(s)” or “intermittently” means a first period and a second period of the same or different durations of time that reoccur at defined intervals. For example, daily intermittent periods would involve doing one act for one day, doing a different act on the following day, and possibly repeating the pattern for as many as two or more day periods as needed or desirable. Similarly, one act such as feeding an animal could be done for a week and a second act such as feeding an animal a different diet could be done for two weeks, and the cycle repeated for a year or for the lifetime of the animal. The same would apply for periods of multiple days, weeks, months, quarters, years, and the like, e.g., daily, two days, three days, four days, five days, six days, weekly, two weeks, three weeks, monthly, two months, quarterly, four months, five months, semi-annual, yearly, and the like.

The term “in conjunction” means that an animal is fed, for a first period, a first diet containing calories that meet the animal's maintenance energy requirements and fed, for a second period, a second diet containing calories that do not meet the animal's maintenance energy requirements according to the invention and the animal is administered a different compound, composition, or other agent (1) together in dietary composition or (2) separately at the same or different frequency using the same or different administration routes at about the same time or periodically. “Periodically” means that the agent is administered on a dosage schedule acceptable for a specific agent and that the food is fed to an animal routinely as appropriate for the particular animal. “About the same time” generally means that the food and agent are administered at the same time or within about 72 hours of each other. “In conjunction” specifically includes administration schemes wherein agent is administered for a prescribed period and the dietary compositions of the invention are administered indefinitely.

The term “complete and balanced” when referring to a food composition means a food composition that contains all known essential nutrients in appropriate amounts and proportions based on recommendations of recognized authorities in the field of animal nutrition, and are therefore capable of serving as a sole source of dietary intake to maintain life or promote production, without the addition of supplemental nutritional sources. Nutritionally balanced pet food and animal food compositions are widely known and widely used in the art, e.g., complete and balanced food compositions formulated according to standards established by the Association of American Feed Control Officials (AAFCO) as of Jan. 1, 2020.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual dietary compositions of the invention physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact a caregiver or instructor to obtain instructions on how to use the kit or safety or technical information about one or more components of a kit.

The term “about” means plus or minus 20%, preferably plus or minus 10%, more preferably plus or minus 5%, most preferably plus or minus 2%.

All percentages expressed herein are by weight or amount of the total weight or amount of the composition unless expressed otherwise.

The invention is not limited to the particular methodology, protocols, and reagents described herein because they may vary. Further, the terminology used herein is for the purpose of describing particular embodiments only and is not intended to limit the scope of the present invention.

As used herein, the singular form of a word includes the plural, and vice versa, unless the context clearly dictates otherwise. Thus, the references “a”, “an”, and “the” are generally inclusive of the plurals of the respective terms. Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive. All embodiments using “comprise”, “comprises”, or “comprising” can be substituted with “essentially consisting of” or “consisting of”.

Unless defined otherwise, all technical and scientific terms and any acronyms used herein have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, are relevant prior art for the present invention and the right to challenge the accuracy and pertinence of such patents, patent applications, publications, and other references is specifically reserved.

### The Invention

In one embodiment, a method for treating, preventing, or delaying the onset of an organ disease or decline of organ function or conditions relating thereto in an animal can comprise feeding the animal a caloric maintenance diet containing calories that meet the animal's maintenance energy requirements for a caloric maintenance period and feeding the animal a caloric reduction diet containing from about 40% to about 60% of the calories contained in the caloric maintenance diet for a caloric reduction period, where the caloric maintenance period and the caloric reduction period is in a ratio of about 4:3.

In one embodiment, a method for treating, preventing, or delaying the onset of an organ disease or decline of organ function or conditions relating thereto in an animal can comprise feeding the animal ad libitum for an ad libitum period and feeding the animal a caloric reduction diet containing from about 40% to about 60% of the animal's maintenance energy requirements for a caloric reduction period, where the ad libitum period and the caloric reduction period is in a ratio of about 4:3.

In another embodiment, a method for reducing the biological age in an adult animal or the biological age of an organ in the adult animal, can comprise feeding the adult animal a caloric maintenance diet containing calories that meet the adult animal's maintenance energy requirements for a caloric maintenance period and feeding the adult animal a caloric reduction diet containing from about 40% to about 60% of the calories contained in the caloric maintenance diet for a caloric reduction period, where the caloric maintenance period and the caloric reduction period is in a ratio of about 4:3.

In another embodiment, a method for reducing the biological age in an adult animal or the biological age of an organ in the adult animal, can comprise feeding the animal ad libitum for an ad libitum period and feeding the adult animal a caloric reduction diet containing from about 40% to about 60% of the animal's maintenance energy requirements for a caloric reduction period, where the ad libitum period and the caloric reduction period is in a ratio of about 4:3.

Notably, the present inventor has unexpectedly discovered that animals fed a specific intermittent feeding pattern, a 4:3 period ratio, with a specific caloric reduction can decrease the biological age of an animal which can treat, prevent or delay onset of organ diseases, decline of organ function, or conditions relating to organ diseases in the animal. For example, an animal can be fed a maintenance diet (or an ad libitum diet) for a period of 4 days and a reduction diet for a period of 3 days. Generally, the reduction diet contains from about 40% to about 60% of the calories contained in the caloric maintenance diet. In one aspect, the reduction diet can have about 50% of the calories.

As such, by way of the present methods, treatment, prevention, or delay of organ diseases, decline of organ function, or conditions relating thereto can include liver diseases or function, heart diseases or function, muscle diseases or function, brain diseases or function, kidney diseases or function, gastrointestinal diseases or function, eye diseases or function, lung diseases or function, bone diseases or function, skin diseases or function, and immune diseases or function.

In one embodiment, the present methods can treat, prevent or delay onset of liver diseases or conditions relating thereto including fatty liver, cirrhosis of the liver, decline in volume of liver and blood flow of the liver with aging, and/or liver fibrosis.

In another embodiment, the present methods can treat prevent, or delay onset of heart diseases or conditions relating thereto including heart hypertrophy, cardiac hypertrophy, myocardial hypertrophy, ventricular hypertrophy, and/or hypertension.

In another embodiment, the present methods can treat prevent, or delay onset of muscle diseases or conditions relating thereto including loss of skeletal muscle mass, loss of strength, sarcopenia, frailty, loss or decline of mobility, and/or muscle atrophy.

In another embodiment, the present methods can treat prevent, or delay onset of brain diseases or conditions relating thereto including brain aging, loss or decline of memory, loss or decline of learning ability, loss or decline of executive function, loss or decline of balance and motor coordination capacity, and/or loss or decline in sensory functions.

In another embodiment, the present methods can treat prevent, or delay onset of kidney diseases or conditions relating thereto including chronic kidney disease, kidney failure, decreased number of functional glomeruli from an increased prevalence of nephrosclerosis, arteriosclerosis, glomerulosclerosis, tubular atrophy with interstitial fibrosis, decline in cortical volume, renal cysts, glomerular filtration rate decline, and/or loss or decline in renal functional reserve.

In another embodiment, the present methods can treat prevent, or delay onset of gastrointestinal diseases or conditions relating thereto including stomach ulcer or inflammation, duodenum ulcer or inflammation, jejunum ulcer, irritable bowel disorder (IBD), constipation, hemorrhoids, colitis, colon polyps, gastroesophageal reflux disease (GERD), diarrhea, gastroenteritis, leaky gut syndrome, leaky gut syndrome-related conditions (anxiety, depression, chronic diarrhea, constipation, or bloating, nutritional deficiencies, fatigue, headaches, confusion, difficulty concentrating, skin problems, such as acne, rashes, or eczema, joint pain, inflammation) and/or bloating and excess gas.

In another embodiment, the present methods can treat prevent, or delay onset of eye diseases or conditions relating thereto including cataract, loss or decline in retinal function, and/or low vision.

In another embodiment, the present methods can treat prevent, or delay onset of lung diseases or conditions relating thereto including chronic obstructive pulmonary disease (COPD), pulmonary fibrosis, lung infection, loss or decline in pulmonary reserve, loss or decline in cough strength, loss or decline in pulmonary muscle function, and/or loss or decline in pulmonary immunologic function.

In another embodiment, the present methods can treat prevent, or delay onset of immune diseases or conditions relating thereto including loss or decline in immune function, and/or immunosenescence, and/or loss or decline in vaccine response.

In another embodiment, the present methods can treat prevent, or delay onset of bone diseases or conditions relating thereto including loss or decline in bone mineral density, bone strength and/or osteoporosis.

In another embodiment, the present methods can treat prevent, or delay onset of skin diseases or conditions relating thereto including wrinkling, loss of elasticity, laxity, rough-textured appearance, age spots, lesions, and dry skin.

While feeding for the caloric reduction period and the caloric maintenance period, as described can be sufficient, the present methods also include embodiments where the feeding pattern is repeated for at least two cycles, for several cycles, for as long as the animal benefits from the feeding pattern (e.g., treats or prevents a liver disease), or for the life of the animal.

While the present methods contemplate the use of the present methods over any cycle of time, such as a 5 day, 7 day, 10 day, 14 day, etc., where, within the cycle, individual maintenance and restrictions periods are in a ratio of 4:3, generally the caloric maintenance period can be 4 days and the caloric reduction period can be 3 days. Additionally, while the individual feedings/days can be spread throughout the cycle in a non-consecutive manner, e.g. cycle of 1 week having 2 days maintenance, then 2 days restricted, then 2 days maintenance, then 1 day restricted, generally, the individual periods can be consecutive, e.g., cycle of 1 week having 4 days maintenance, then 3 days restricted. As such, in one aspect, the 4 days and the 3 days can be consecutive, and in another aspect, the 4 days and the 3 days can be non-consecutive.

While feeding for the caloric reduction period and the ad libitum period, as described can be sufficient, the present methods also include embodiments where the feeding pattern is repeated for at least two cycles, for several cycles, for as long as the animal benefits from the feeding pattern (e.g., treats or prevents a liver disease), or for the life of the animal.

While the present methods contemplate the use of the present methods over any cycle of time, such as a 5 day, 7 day, 10 day, 14 day, etc., where, within the cycle, individual ad libitum and restrictions periods are in a ratio of 4:3, generally the ad libitum period can be 4 days and the caloric reduction period can be 3 days. Additionally, while the individual feedings/days can be spread throughout the cycle in a non-consecutive manner, e.g. cycle of 1 week having 2 days ad libitum, then 2 days restricted, then 2 days ad libitum, then 1 day restricted, generally, the individual periods can be consecutive, e.g., cycle of 1 week having 4 days ad libitum, then 3 days restricted. As such, in one aspect, the 4 days and the 3 days can be consecutive, and in another aspect, the 4 days and the 3 days can be non-consecutive.

As discussed herein, while the present intermittent dieting can be for any amount of time and for any amount of cycles, in one embodiment, the feeding for the caloric maintenance period and the feeding for the caloric reduction period are repeated over a combined period of at least 1 month. In one aspect, the feeding for the caloric maintenance period and the feeding for the caloric reduction period can be repeated over a period of at least 6 months. In other aspects, the feeding for the caloric maintenance period and the feeding for the caloric reduction period can be repeated over a period of at least 1 year, 2 years, 5 years, 10 years, or even over the remaining life of the animal.

As discussed herein, while the present intermittent dieting can be for any amount of time and for any amount of cycles, in one embodiment, the feeding for the ad libitum period and the feeding for the caloric reduction period are repeated over a combined period of at least 1 month. In one aspect, the feeding for the ad libitum period and the feeding for the caloric reduction period can be repeated over a period of at least 6 months. In other aspects, the feeding for the ad libitum period and the feeding for the caloric reduction period can be repeated over a period of at least 1 year, 2 years, 5 years, 10 years, or even over the remaining life of the animal.

In one embodiment, the methods of the invention are implemented in conjunction with the administration of a therapeutic agent, or any other agent that imparts a health benefit. Any such agents that are compatible with the feeding patterns of the invention can be used in the invention. In various embodiments, the agent can be carnitine, isoflavones, pyruvate, fish oil, omega-3 polyunsaturated fatty acids, omega-6 polyunsaturated fatty acids, monounsaturated fatty acids (omega 7 fatty acids and omega 9 fatty acids), fibers, calcium, resistant starch, medium chain triglycerides, green tea extract, phentermine, diethylpropion, orlistat, sibutramine, megestrol, resveratrol, botanic polyphenols, phenylpropanolamine, inhibitors of amylase and/or alpha-glucosidase such as acarbose, phase 2 (white bean extract), Reducose® (mulberry leaves extract), inhibitors of lipase such as orlistat, oxandrolone, oleoylethanolamide, probiotics, ephedra, conjugated linoleic acid, glucomannan, and mixtures thereof.

The methods described herein can be useful for reducing the biological age of an animal or organ of the animal as well as treating, preventing, or delaying onset of an organ disease or organ functional decline, or conditions relating thereto for any animal. In one aspect, such methods can be directed to companion animals, including those whose diet is controlled by an owner or caregiver. In one specific aspect, the animals can be dogs and/or cats. In one embodiment, the animal can be an adult animal. In another embodiment, the animal can be a senior animal. In still another embodiment, the animal can be an aging animal.

In a further aspect, the invention provides kits suitable for implementing the methods of the invention. The kits comprise in separate containers in a single package or in separate containers in a virtual package, as appropriate for the kit component, (1) a complete and balanced first food composition containing calories that meet an animal's maintenance energy requirements; (2) a complete and balanced second food composition containing calories that do not meet the animal's maintenance energy requirements; and (3) instructions for using the food compositions for at least one of reducing the biological age of the animal or organ of the animal; or treating, preventing, or delaying onset of an organ disease, or organ functional decline, or conditions relating thereto by feeding the animal for a first period the first food composition and feeding the animal for a second period the second food composition. In certain embodiments, the kits further comprise one or more of one or more health imparting agents or therapeutic agents.

When the kit comprises a virtual package, the kit is limited to instructions in a virtual environment in combination with one or more physical kit components. Generally, the kit contains the food compositions and other physical components in amounts sufficient to implement the methods of the invention and the virtual package contains the instructions relating to using the physical components to implement the methods of the invention.

In another aspect, the invention provides a means for communicating information about or instructions for reducing the biological age of the animal or organ of the animal; or treating, preventing, or delaying onset of an organ disease, or organ functional decline, or conditions relating thereto by feeding the animal for caloric maintenance period a caloric maintenance diet containing calories that meet the animal's maintenance energy requirements and feeding the animal for a caloric reduction period a caloric reduction diet containing calories that do not meet the animal's maintenance energy requirements, and optionally a therapeutic agent or other health imparting agent. The means comprises a document, digital storage media, optical storage media, audio presentation, or visual display containing the information or instructions. In certain embodiments, the communication means is a displayed web site, visual display, brochure, product label, package insert, advertisement, handout, public announcement, audiotape, videotape, DVD, CD-ROM, computer readable chip, computer readable card, computer readable disk, computer memory, or combination thereof containing such information or instructions.

Useful information includes one or more of (1) recommended feeding schedules for the animal, particularly based on the animal's species and body condition (e.g., liver disease), (2) recommended therapeutic agent or health imparting agent to be administered in conjunction with the use of the recommended feeding pattern, and (3) contact information for animals or their caregivers to use if they have a question about the invention and its use.

### EXAMPLES

The invention can be further illustrated by the following examples, although it will be understood that these examples are included merely for purposes of illustration and are not intended to limit the scope of the invention unless otherwise specifically indicated.

### Example 1—Rat Organ Study

Male post-weaned rats were fed with a high fat diet (HFD, 45% fat) for 14 weeks to induce overweight in the rats. After this weight gain feeding period, the rat were randomized into the following groups with 12 rats per group for 6 month. Control group: the rats that received the AlN-93M diet (Control) continued with 100% MER daily for 6 months. Chronic restriction (CR) group: the rats were fed 25% less than their MER from reduced dietary carbohydrate intake daily with the 25% diet. Intermittent caloric restriction (ICR) group: The rats were fed 50% less than their MER from reduced dietary carbohydrate intake three days per week with the 50% diet, and 100% of their MER with the control diet for the remaining four days per week. Composition of diets are listed in Table 1.

TABLE 1

| | Control | 25% Diet | 50% Diet |
|---|---|---|---|
| Protein %* | 12.57 | 16.76 | 25.15 |
| Fat %* | 4.00 | 5.32 | 8.00 |
| Ash %* | 2.80 | 3.73 | 5.60 |
| Crude Fiber %* | 5.00 | 5.60 | 7.20 |
| Moisture %* | 10.00 | 10.00 | 10.00 |
| Carbohydrates %* | 65.63 | 58.59 | 44.06 |

*% are weight percentages of total diet

During the 6 months of feedings study, the rats in all test groups consumed the same amount of protein, fat, vitamins and minerals as the rats in the control group. The reduced calories came only from reduced carbohydrates intake from the specially-formulated diets of Table 1.

At the end of the study, the rats were about 11 months of age when tissue samples were collected. Liver samples were collected and subjected to epigenetic biological clock assay to determine the biological ages of the livers from the groups as provided in Table 2.

TABLE 2

| | Avrage weekely | Reduction in |
|---|---|---|
| Group | caloric restriction | Biological Age (%) |
| Control | NA | 0 |
| CR | 25% | 15.53 |
| ICR | 21.4% | 23.04 |

The results showed that the biological age and chronological ages of the liver of control rats were identical. 25% CR, which has been previously reported as an anti-aging intervention, reduced the biological age of the rat liver by 15.53%. Surprisingly, the ICR regimen has less caloric restriction (21.4%) compared with CR (25%), but the regimen had the strongest effects on biological age of rat liver by reducing the biological age of the rats' liver by 23.04%. To reiterate, even though the rats on the present ICR regimen consumed more calories, they had younger livers than the rats on the CR diet which was wholly unpredicted.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method for treating, preventing, or delaying the onset of an organ disease, or decline of organ function, or condition relating thereto in an animal, the method comprising:
feeding the animal a caloric maintenance diet containing calories that meet the animal's maintenance energy requirements for a caloric maintenance period; and
feeding the animal a caloric reduction diet containing from about 40% to about 60% of the calories contained in the caloric maintenance diet for a caloric reduction period;
wherein the caloric maintenance period and the caloric reduction period is in a ratio of about 4:3.

2. The method of claim 1, wherein the caloric maintenance period is 4 days and caloric reduction period is 3 days.

3. The method of claim 2, wherein the 4 days and the 3 days are consecutive.

4. The method of claim 2, wherein the 4 days and the 3 days are non-consecutive.

5. The method of claim 1, wherein the feeding for the caloric maintenance period and the feeding for the caloric reduction period are repeated over a period of at least 1 month.

6. The method of claim 1, wherein the feeding for the caloric maintenance period and the feeding for the caloric reduction period are repeated over a period of at least 6 months.

7. The method of claim 1, wherein the caloric reduction diet contains about 50% of the calories needed to meet the animal's daily maintenance requirement for energy.

8. The method of claim 1, wherein the organ disease or condition relating thereto is selected from the group consisting of: fatty liver, cirrhosis of the liver, decline in volume of liver and blood flow of the liver with aging, liver fibrosis, heart hypertrophy, cardiac hypertrophy, myocardial hypertrophy, ventricular hypertrophy, hypertension, loss of skeletal muscle mass, loss of strength, sarcopenia, frailty, loss or decline of mobility, muscle atrophy, brain aging, loss or decline of memory, loss or decline of learning ability, loss or decline of executive function, loss or decline of balance and motor coordination capacity, loss or decline in sensory functions, chronic kidney disease, kidney failure, decreased number of functional glomeruli from an increased prevalence of nephrosclerosis, arteriosclerosis, glomerulosclerosis, tubular atrophy with interstitial fibrosis, decline in cortical volume, renal cysts, glomerular filtration rate decline, loss or decline in renal functional reserve, stomach ulcer or inflammation, duodenum ulcer or inflammation, jejunum ulcer, irritable bowel disorder (IBD), constipation, hemorrhoids, colitis, colon polyps, gastroesophageal reflux disease (GERD), leaky gut syndrome, diarrhea, gastroenteritis, bloating & excess gas, cataract, loss or decline in retinal function, low vision, chronic obstructive pulmonary disease (COPD), pulmonary fibrosis, lung infection, loss or decline in pulmonary reserve, loss or decline in cough strength, loss or decline in pulmonary muscle function, loss or decline in pulmonary immunologic function, loss or decline in immune function, immunosenescence, loss or decline in vaccine response, bone diseases, loss or decline in bone mineral density, loss or decline in bone strength, osteoporosis, skin diseases, wrinkling, loss of skin elasticity, skin laxity, rough-textured skin appearance, age spots, skin lesions, dry skin, or combinations thereof.

9. A method for reducing the biological age in an adult animal or the biological age of an organ in the adult animal, the method comprising:
feeding the adult animal a caloric maintenance diet containing calories that meet the adult animal's maintenance energy requirements for a caloric maintenance period; and
feeding the adult animal a caloric reduction diet containing from about 40% to about 60% of the calories contained in the caloric maintenance diet for a caloric reduction period;
wherein the caloric maintenance period and the caloric reduction period is in a ratio of about 4:3.

10. The method of claim 9, wherein the caloric maintenance period is 4 days and caloric reduction period is 3 days.

11. The method of claim 9, wherein the caloric maintenance feeding period and the caloric reduction period are consecutive.

12. The method of claim 9, wherein the feeding for the caloric maintenance period and the feeding for the caloric reduction period are repeated over a period of at least 1 month.

13. The method of claim 9, wherein the feeding for the caloric maintenance period and the feeding for the caloric reduction period are repeated over a period of at least 6 months.

14. The method of claim 9, wherein the caloric reduction diet contains about 50% of the calories needed to meet the animal's daily maintenance requirement for energy.

15. The method of claim 9, wherein the adult animal is a senior animal.
